(19) United States
(12) Patent Application Publication
(10) Pub. No.: US 2006/0090861 A1
(43) Pub. Date: May 4, 2006

(54) Direct transmission garage door opener

(76) Inventor: Jay Chung-Chieh Wu, Burlington (CA)

Correspondence Address: JAY CHUNG-CHIEH WU, 5464 Blue Spruce Ave., Burlington, ON, L7L 7C4, CA

(21) Appl. No.: 11/247,089

(22) Filed: Oct. 12, 2005

(30) Foreign Application Priority Data
Oct. 26, 2004 (CA) 2,483,356

(51) Int. Cl. E05F 15/00

(52) U.S. Cl. 160/188

(57) ABSTRACT

An Improved garage door opener wherein a motor is coupled to the drive shaft of the door at upper side with gear attached to the drive shaft thereof to operate the garage door and a clutch mechanism is provided to move the gear from engaging location to allow the door to be manually opened or closed. This invention results in a quieter environment both in garage and in the room above garage and a substantial simplification over current garage door openers which require a rail and trolley mechanism for opening and closing the door. No extra space required for this opener.

### DESCRIPTION

This invention relates in general to garage door openers and in particular to a simplified transmission method for a garage door opener which can be mounted above the drive shaft to open and close the door and which reduces the resonant effect from the motor and eliminates many parts of prior art garage door openers.

Prior art garage door openers provide for a track which is mounted at the center of the door between the guide rails of the door and which carries a trolley which is moved either by a lead screw or a chain/belt drive so as to move the trolley back and forth on the guide rail. The trolley is connected to the door and opens and closes the door as the trolley moves.

Efforts to simplify the drive mean and eliminate parts had been made in 1982 by U.S. Pat. No. 4,472,910 which mount the motor at one end of the drive shaft in. Currently, in reality, the most popular garage door opener available in the market still use track with trolley.

The present invention comprises a closure operator for an overhead door comprising a pair of guide rails with vertical and horizontal portions in which the door is guided to open and close it, a frame member, a drive shaft rotatably supported by said frame member above the vertical portions of said rails, a motor assembly connected to drive said drive shaft in either direction to open and close said door, and a spring connected clutch stick mounted under said motor assembly to selectively disconnect said motor assembly and said drive shaft at any time and whether the motor means in energized or not, wherein said gear is formed with two pin screws and two identical grooved half gears engageable to adapter which is mounted to said drive shaft by pin and screws and provided spokes and open sections for engaging and disengaging the transmission as the said clutch stick is staying or move to the right side by pull down rope and handle which located in the end of said drive shaft.

Other objects, features and advantage of the invention will be apparent from the following description of certain preferred embodiments thereof taken in conjunction with the accompanying drawings although variations and modifications may be effected without departing from the spirit and scope of the novel concepts of the disclosure, and in which:

### ON THE DRAWINGS

FIG. 1 is a plan view of the invention installed on a garage door;

FIG. 2 is a sectional view taken on line II-II from FIG. 1;

FIG. 3 is an exploded view of the drive and clutch mechanism of the invention.

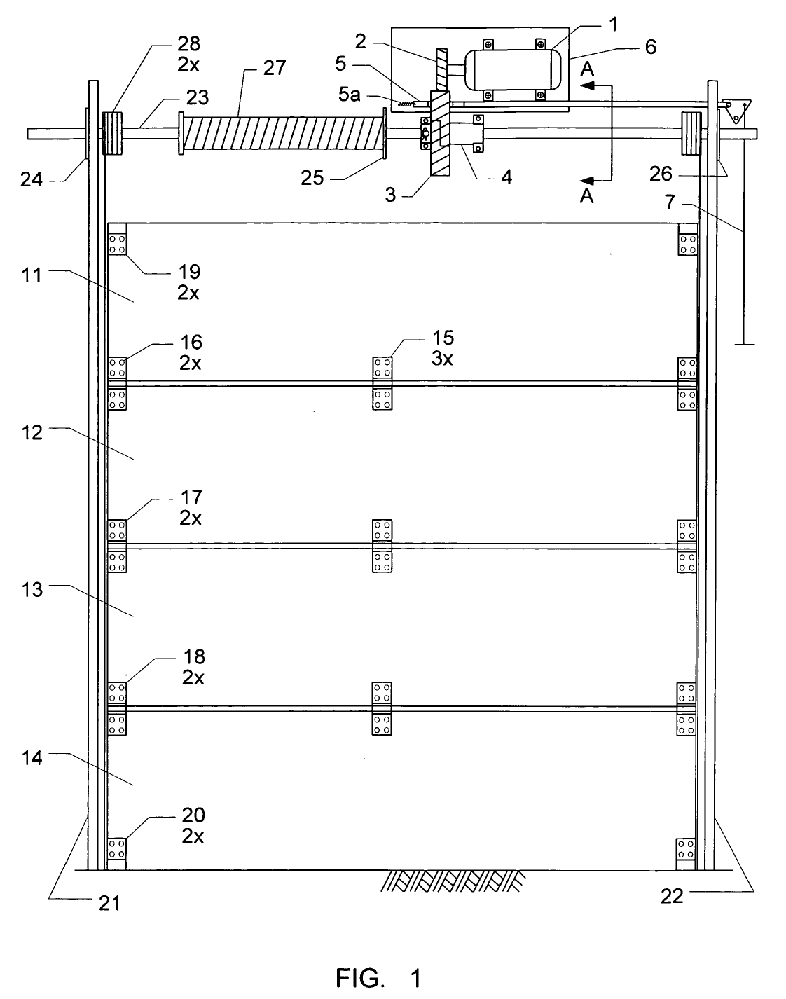

FIG. 1 illustrates a garage door which is formed with panels 11, 12, 13 and 14 which are connected together by hinges 15, 16, 17 and 18. Hinges 16, 17 and 18 are provided with rollers. Other rollers located in brackets 19 and 20. The door open and close as rollers ride in rails 21 and 22 in a conventional manner.

A drive shaft 23 is supported by brackets 24, 25 and 26 from the wall of the door and counter balance spring 27 are connected to the shaft 23 so as to counter balance the weigh of the door in a conventional manner.

Pair of pull-up reels 28 is mounted on shaft 23 on opposite ends of the door and carry cables 29 which are connected to the lower panel 14 of the door at bottom side of bracket 20 with suitable clamps.

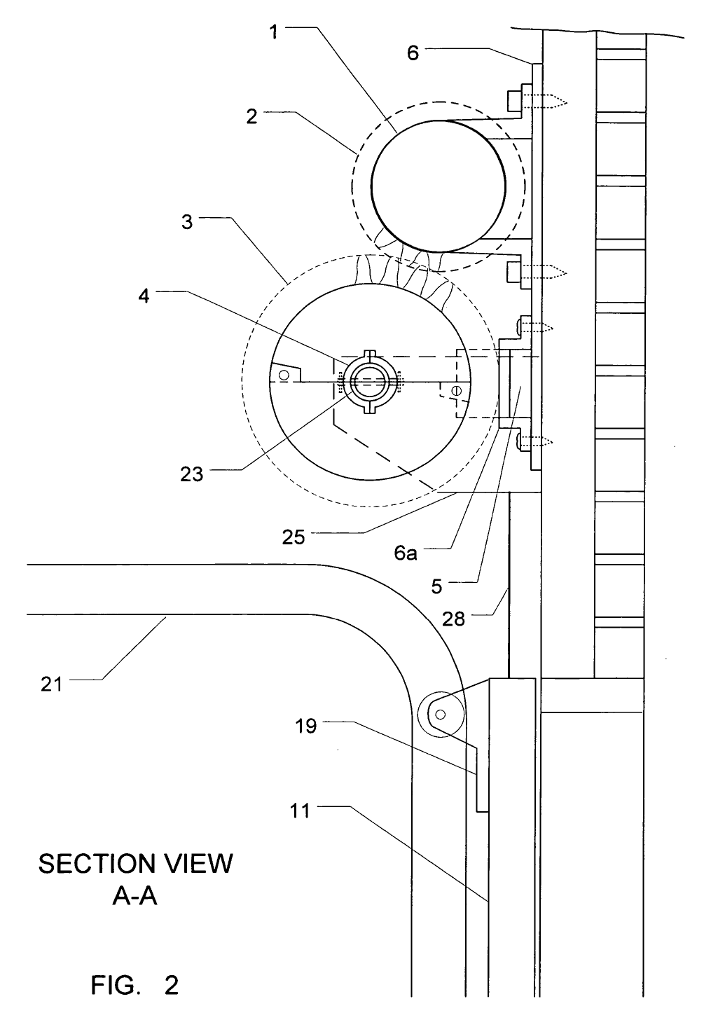

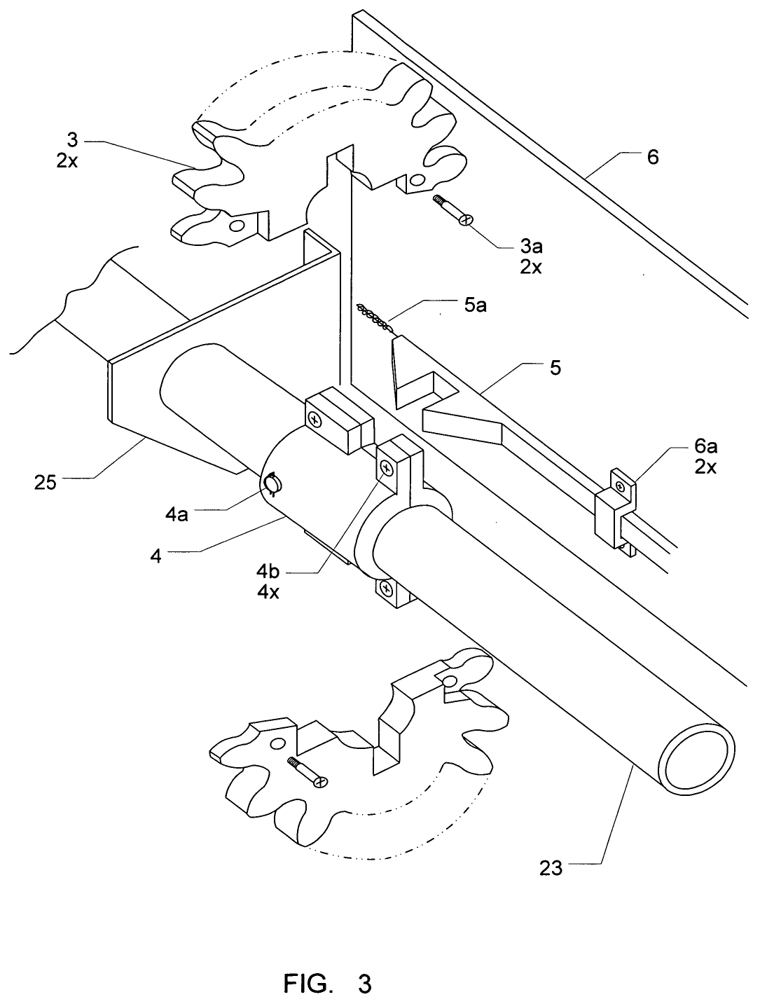

FIG. 2 shows a motor 1 is mounted on wall above garage door via base plate 6 and has an output gear 2 mates with drive gear 3 which is formed by two half gears with pin screws enclose the adapter 4 which is connected to drive shaft 23 with a through pin and screws so drive gear 3 can slide within the range between pin 4a and the longer spoke on the other side of adapter 4, reference FIG. 3. A spring biased clutch stick 5 is mounted on said base plate under the motor assembly with guides 6a so the clutch stick can slide back and forth horizontally push the drive gear 3 disengaging and engaging to output gear 2.

If the door is in the down position, as shown in FIG. 2, when the motor is energized, the motor output shaft turns in clockwise direction so that the output gear 2 turns drive gear 3 in counterclockwise direction therefore the adapter 4, drive shaft 23 and pair of pull-up reels 28 turn and then pull up the garage door as the cables are wound around the reels 28. The motor will stop when the top edge of panel 11 touch the limit switch located in top end of guide rail 21. When the door is to be lowered the motor will turn output gear 2 in the opposite directions so the reel 28 will release cable as the panels 11, 12, 13 and 14 lower down by their own weigh left from counter balance spring 27 and then close the door until a second limit switch in the lower end of rail 21 has been touched to stop the motor.

At any time it is desired to disengage the drive gear 3 from the adapter 4 as for example when there has been a power failure, the rope and handle 7 can be pulled down to move the clutch stick 5 to the right of the open position thus allowing the door to be manually opened or closed. When it is desired to reengage the drive gear 3, just release the pull down force from the rope and handle 7 then the clutch stick 5 will moved to the left side and push the drive gear 3 back to its engaged position in the adapter 4.

Conventional control and safety system still can be used in this invention except the light seat has to separate from the motor assembly to any other upper wall location where will not cause shadow from garage door. An integrated wall mount switch unit which combines the light seat and the conventional wall mount switch together and placed in a convenient location such as aside door frame is the idea in this invention.

Although the invention has been described with respect to preferred embodiment, it is not to be so limited as changes and modifications can be made which are within the full intended scope of the invention as defined by the appended claims.

### DESCRIPTION

This invention relates in general to garage door openers and in particular to a simplified transmission method for a garage door opener which can be mounted above the drive shaft to open and close the door and which reduces the resonant effect from the motor and eliminates many parts of prior art garage door openers.

Prior art garage door openers provide for a track which is mounted at the center of the door between the guide rails of the door and which carries a trolley which is moved either by a lead screw or a chain/belt drive so as to move the trolley back and forth on the guide rail. The trolley is connected to the door and opens and closes the door as the trolley moves.

Efforts to simplify the drive mean and eliminate parts had been made in 1982 by U.S. Pat. No. 4,472,910 which mount the motor at one end of the drive shaft in. Currently, in reality, the most popular garage door opener available in the market still use track with trolley.

The present invention comprises a closure operator for an overhead door comprising a pair of guide rails with vertical and horizontal portions in which the door is guided to open and close it, a frame member, a drive shaft rotatably supported by said frame member above the vertical portions of said rails, a motor assembly connected to drive said drive shaft in either direction to open and close said door, and a spring connected clutch stick mounted under said motor assembly to selectively disconnect said motor assembly and said drive shaft at any time and whether the motor means in energized or not, wherein said gear is formed with two pin screws and two identical grooved half gears engageable to adapter which is mounted to said drive shaft by pin and screws and provided spokes and open sections for engaging and disengaging the transmission as the said clutch stick is staying or move to the right side by pull down rope and handle which located in the end of said drive shaft.

Other objects, features and advantage of the invention will be apparent from the following description of certain preferred embodiments thereof taken in conjunction with the accompanying drawings although variations and modifications may be effected without departing from the spirit and scope of the novel concepts of the disclosure, and in which:

### ON THE DRAWINGS

FIG. 1 is a plan view of the invention installed on a garage door;

FIG. 2 is a sectional view taken on line II-II from FIG. 1;

FIG. 3 is an exploded view of the drive and clutch mechanism of the invention.

FIG. 1 illustrates a garage door which is formed with panels 11, 12, 13 and 14 which are connected together by hinges 15, 16, 17 and 18. Hinges 16, 17 and 18 are provided with rollers. Other rollers located in brackets 19 and 20. The door open and close as rollers ride in rails 21 and 22 in a conventional manner.

A drive shaft 23 is supported by brackets 24, 25 and 26 from the wall of the door and counter balance spring 27 are connected to the shaft 23 so as to counter balance the weigh of the door in a conventional manner.

Pair of pull-up reels 28 is mounted on shaft 23 on opposite ends of the door and carry cables 29 which are connected to the lower panel 14 of the door at bottom side of bracket 20 with suitable clamps.

FIG. 2 shows a motor 1 is mounted on wall above garage door via base plate 6 and has an output gear 2 mates with drive gear 3 which is formed by two half gears with pin screws enclose the adapter 4 which is connected to drive shaft 23 with a through pin and screws so drive gear 3 can slide within the range between pin 4a and the longer spoke on the other side of adapter 4, reference FIG. 3. A spring biased clutch stick 5 is mounted on said base plate under the motor assembly with guides 6a so the clutch stick can slide back and forth horizontally push the drive gear 3 disengaging and engaging to output gear 2.

If the door is in the down position, as shown in FIG. 2, when the motor is energized, the motor output shaft turns in clockwise direction so that the output gear 2 turns drive gear 3 in counterclockwise direction therefore the adapter 4, drive shaft 23 and pair of pull-up reels 28 turn and then pull up the garage door as the cables are wound around the reels 28. The motor will stop when the top edge of panel 11 touch the limit switch located in top end of guide rail 21. When the door is to be lowered the motor will turn output gear 2 in the opposite directions so the reel 28 will release cable as the panels 11, 12, 13 and 14 lower down by their own weigh left from counter balance spring 27 and then close the door until a second limit switch in the lower end of rail 21 has been touched to stop the motor.

At any time it is desired to disengage the drive gear 3 from the adapter 4 as for example when there has been a power failure, the rope and handle 7 can be pulled down to move the clutch stick 5 to the right of the open position thus allowing the door to be manually opened or closed. When it is desired to reengage the drive gear 3, just release the pull down force from the rope and handle 7 then the clutch stick 5 will moved to the left side and push the drive gear 3 back to its engaged position in the adapter 4.

Conventional control and safety system still can be used in this invention except the light seat has to separate from the motor assembly to any other upper wall location where will not cause shadow from garage door. An integrated wall mount switch unit which combines the light seat and the; conventional wall mount switch together and placed in a convenient location such as aside door frame is the idea in this invention.

Although the invention has been described with respect to preferred embodiment, it is not to be so limited as changes and modifications can be made which are within the full intended scope of the invention as defined by the appended claims.

The embodiments of the invention in which an exclusive property or privilege it claimed are defined as follows:

1. A garage door operator comprising, a motor assembly to be attached to a wall or ceiling above a garage door, a gear assembly or a sprocket with chain assembly, an adapter assembly mounted to the drive shaft of said garage door and engage to said gear assembly, a spring biased clutch mechanism, an integrated wall mount switch with light seat and a control unit assembly.

2. A garage door operator according to claim 1 wherein said motor assembly use its output gear or sprocket to turn said drive shaft of said garage door through either the said gear assembly which is composed by sectional gears with pin(s) or/and screw(s), or the sprocket with chain assembly by split type sprocket, and then turn the said adapter assembly.

3. A garage door operator according to claim 1 wherein said adapter assembly is used to transmit the torque force from said gear assembly or a sprocket with chain assembly to said drive shaft of said garage door and this said adapter assembly is connected to said drive shaft of said garage door by using through hole(s) in said drive shaft and pin(s) or screws.
